(19) United States
(12) Patent Application Publication
(10) Pub. No.: US 2010/0191886 A1
(43) Pub. Date: Jul. 29, 2010

(54) Resource-limited electronic device comprising means for prioritizing services

(76) Inventors: Tuomo Saarikivi, Helsinki (FI); Kari Karikkainen, Espoo (FI); Paul Higgin, Derby (GB)

Correspondence Address: HARRINGTON & SMITH, 4 RESEARCH DRIVE, Suite 202, SHELTON, CT, 06484-6212, US

(21) Appl. No.: 12/308,305

(22) PCT Filed: Jun. 23, 2006
(86) PCT No.: PCT/IB2006/001716

§ 371 Date: Mar. 29, 2010

(51) Int. Cl. G06F 13/26

(52) U.S. Cl. 710/264

(57) ABSTRACT

An electronic device, including: a storage device operable to store first priority data associated with a first signal, and second priority data associated with a second signal; and a processor operable to compare the first priority data and the second priority data, and when the second priority data is indicative of a higher priority than the first priority data, to use the second signal while suspending use of the first signal.

### FIELD OF THE INVENTION

Embodiments of the present invention relate to an electronic device. In particular, they relate to a portable electronic device for receiving broadcast/multicast services, such as those provided using Digital Video Broadcasting-Handheld (DVB-H).

### BACKGROUND TO THE INVENTION

In recent years the number of functions and services that portable electronic devices and, in particular, mobile radio telephones provide to a user have increased substantially. In order to provide these functions and services, there has been an increase in the processing power and the amount of memory included in portable electronic devices. However, in any electronic device the amount of processing and memory resources that are available to perform functions and provide services is limited.

Digital Video Broadcasting-Handheld (DVB-H) is a technical specification for bringing broadcast/multicast services to portable electronic devices. DVB-H may be used to provide video content to portable electronic devices, such as television channels. Typically, DVB-H services such as television channels are processor and memory intensive.

Currently, if a portable electronic device attempts to perform more functions or provide more services than the portable electronic device has the resources to handle, the operating system of the portable electronic device may crash or may indicate to the user that it is not able to provide all of the requested functions/services in an error message.

### BRIEF DESCRIPTION OF THE INVENTION

According to a first aspect of the present invention, there is provided an electronic device, comprising: a storage device operable to store first priority data associated with a first signal, and second priority data associated with a second signal; and a processor operable to compare the first priority data and the second priority data, and when the second priority data is indicative of a higher priority than the first priority data, to use the second signal while suspending use of the first signal.

According to a second aspect of the present invention, there is provided a method of using a signal in an electronic device, comprising: storing first priority data associated with a first signal, and second priority data associated with a second signal; and comparing the first priority data and the second priority data; and using the second signal while suspending use of the first signal, when the second priority data is indicative of a higher priority than the first priority data.

According to a third aspect of the present invention, there is provided a computer program for use in an electronic device, comprising: means for comparing stored first priority data, associated with a first signal, and stored second priority data, associated with a second signal; and means for using the second signal while suspending use of the first signal, when the second priority data is indicative of a higher priority than the first priority data.

According to a fourth aspect of the present invention, there is provided a chipset for use in an electronic device, comprising: means for comparing stored first priority data, associated with a first signal, and stored second priority data, associated with a second signal; and means for using the second signal while suspending use of the first signal, when the second priority data is indicative of a higher priority than the first priority data.

According to a fifth aspect of present invention, there is provided an electronic device, comprising: a storage device operable to store first priority data indicating a first priority level, associated with a first signal, and second priority data indicating a second priority level, associated with a second signal; and a processor operable to compare the first priority level and the second priority level, and operable to select for use one of the first and second signals and to restrict use of the other of the first and second signals in dependence on the comparison.

According to a sixth aspect of present invention, there is provided a method of using a signal in an electronic device, comprising: storing first priority data indicating a first priority level, associated with a first signal, and second priority data indicating a second priority data, associated with a second signal; comparing the first priority level and the second priority level; and selecting for use one of the first and second signals and restricting use of the other of the first and second signals in dependence on the comparison.

According to a seventh aspect of present invention, there is provided a computer program for use in an electronic device, comprising: means for comparing a first stored priority level, associated with a first signal, and a second stored priority level, associated with a second signal; and means for selecting for use one of the first and second signals and for restricting use of the other of the first and second signals in dependence on the comparison.

According to a eighth aspect of present invention, there is provided a chipset for use in an electronic device, comprising: means for comparing a first stored priority level, associated with a first signal, and a second stored priority level, associated with a second signal; and means for selecting for use one of the first and second signals and for restricting use of the other of the first and second signals in dependence on the comparison.

In embodiments of the invention, an electronic device is able to prioritise whether it uses a first signal or a second signal, depending on the priority data associated with those signals. This enables the device to use the most important signal, resulting in more efficient management of the limited processing resources of the electronic device.

### BRIEF DESCRIPTION OF THE DRAWINGS

For a better understanding of the present invention reference will now be made by way of example only to the accompanying drawings in which:

FIG. 1 illustrates a portable electronic device;

FIG. 2 illustrates a core network providing broadcast/multicast services to a plurality of portable electronic devices; and

FIG. 3 illustrates a method of managing the broadcast/multicast services that are provided to a user by a portable electronic device.

### DETAILED DESCRIPTION OF EMBODIMENTS OF THE INVENTION

The Figures illustrate an electronic device 10, comprising: a storage device 16 operable to store first priority data 18 associated with a first signal 140, and second priority data 19 associated with a second signal 130; and a processor 11 operable to compare the first priority data 18 and the second priority data 19, and when the second priority data 19 is indicative of a higher priority than the first priority data 18, to use the second signal 130 while suspending use of the first signal 140.

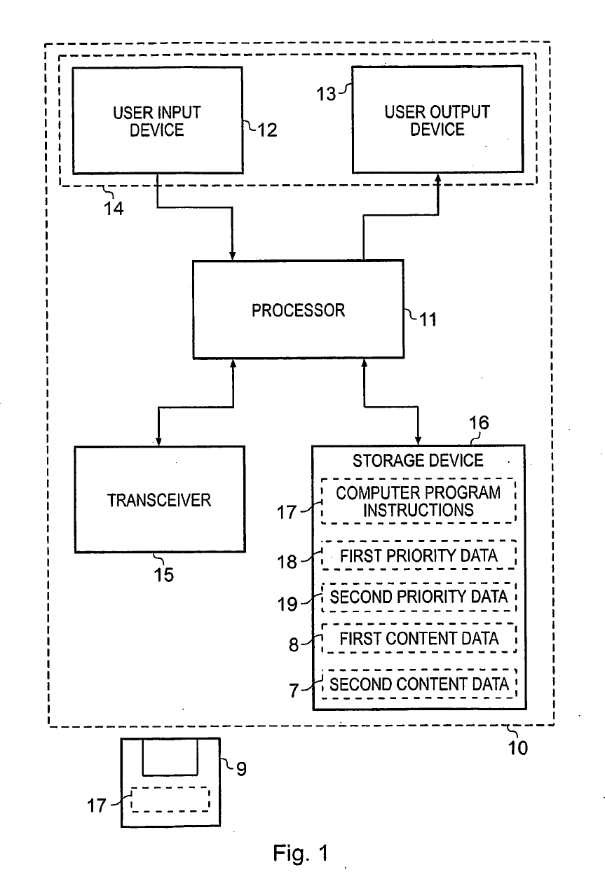

FIG. 1 is a schematic illustration of a portable electronic device 10. The portable electronic device 10 comprises a processor 11, a user input device 12, a user output device 13, a transceiver 15 and a storage device 16.

The processor 11 is connected to receive an input from the user input device 12 and the transceiver 15, and to provide an output to the user output device 13 and the transceiver 15. The processor 11 is also connected to write to and read from the storage device 16.

The processor 11 may be, for example, a programmable processor that interprets computer program instructions 17 and processes data. Alternatively, the processor 11 may be, for example, a hardwired, application-specific integrated circuit (ASIC).

The user input device 12 and the user output device 13 together form a user interface 14. The user input device 12 may, for instance, comprise a keypad, an audio input or other device for user input. The user output device 13 is for conveying information to a user and may, for instance, comprise a display, an audio output or other device for user output. The user input device 12 and the user output device 13 may be combined, for instance, in a touch sensitive display device.

The storage device 16 comprises computer program instructions 17, first priority data 18, second priority data 19, first content data 8 and second content data 7. These items may be stored in the storage device 16 transiently or permanently.

The storage device 16 may be a single memory unit or a plurality of memory units. If the storage device 16 comprises a plurality of memory units, part or the whole of the computer program instructions 17, the first priority data 18, the second priority data 19, the first content data 8 and the second content data 7 may be stored in the same or different memory units.

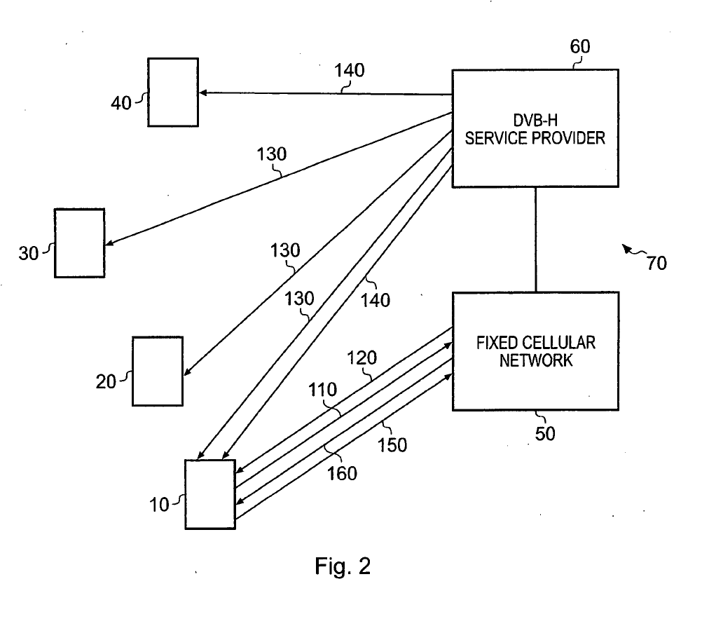

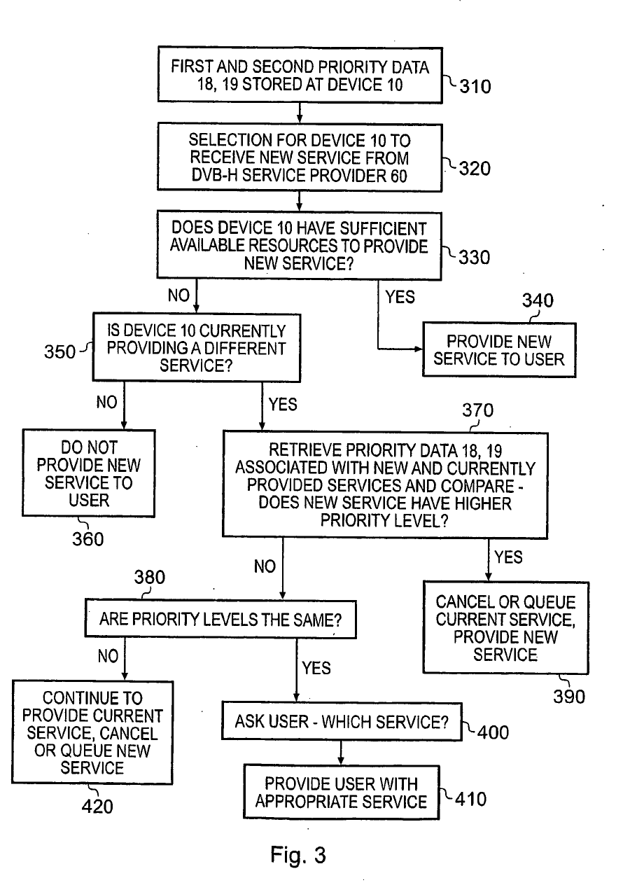

The portable electronic device 10 illustrated in FIG. 1 is suitable for carrying out the method described in relation to FIGS. 2 and 3. The computer program instructions 17 control the operation of the portable electronic device 10 when loaded into the processor 11. The computer program instructions 17 provide the logic and routines which enable the portable electronic device 10 to perform the method illustrated in FIGS. 2 and 3.

The computer program instructions 17 provide: means for comparing stored first priority data 18, associated with a first signal 140, and second stored priority data 19, associated with a second signal 130; and means for using the second signal 130 while suspending use of the first signal 140, when the second priority data 19 is indicative of a higher priority than the first priority data 18.

The computer program instructions 17 may arrive at the portable electronic device 10 via an electromagnetic carrier signal or be copied from a physical entity 9 such as a computer program product, memory device or a record medium such as a CD-ROM or a DVD. A record medium 9 is illustrated in FIG. 1.

FIG. 2 illustrates a core network 70 for providing first and second content/services via first and second radio frequency signals 140, 130 to a plurality of portable electronic devices 10, 20, 30, 40. The first and second signals 140, 130 include first and second media streams. The first and second media streams comprise first and second content/service data 8, 7.

The core network 70 comprises a fixed cellular network 50 connected to a broadcast/multicast service provider 60. The broadcast/multicast service provider 60 is configured to provide either broadcast services or multicast services using DVB-H.

DVB-H operates using a technique known as “time slicing”. Using this technique, several different services may be provided using a single physical channel. The DVB-H service provider 60 operates by periodically allocating a period of time to a service. For example, the DVB-H service provider 60 transmits first content data, corresponding to a first service, in a first period of time on a physical channel, and then transmits second content data, corresponding to a second service, over a second period of time on the same physical channel.

The DVB-H service provider 60 may be used to transmit eight services on a single physical channel. In this case, the DVB-H service provider 60 sequentially transmits content data relating to each of the eight services in “data bursts”. The DVB-H service provider 60 may provide further services by using additional physical channels.

FIG. 2 illustrates a DVB-H service provider 60 transmitting a first signal 140, corresponding to a first service and a second signal 130, corresponding to a second service. The first signal 140 and the second signal 130 may be transmitted on the same or different physical channels.

The DVB-H service provider 60 may be used to provide different types of services or content to the portable electronic devices 10, 20, 30, 40. For instance, the DVB-H service provider 60 may transmit television channel data. Television channel data is periodically transmitted by the DVB-H service provider 60 to the portable electronic devices 10, 20, 30, 40 (as described above). The portable electronic devices 10, 20, 30, 40 receive the data in bursts from the DVB-H service provider 60 and store the data in a buffer in a storage device 16. The processor 11 of the portable electronic devices 10, 20, 30, 40 reads the data in the buffer and provides a continuous stream of data to a user output device 13 so that the user may watch an uninterrupted television channel.

The DVB-H service provider 60 may also provide services other than television channel services to the portable electronic devices 10, 20, 30, 40. For instance, it may provide a software update service or a news or weather update service. Data corresponding to these services may be transmitted to the portable electronic devices 10, 20, 30, 40 periodically, for example each hour, each day or each week. Even though information relating to these services is received by the portable electronic devices 10, 20, 30, 40 periodically, the services may provide a continuous service to a user. For example, weather forecast information may be continuously displayed on a user's device 10, 20, 30, 40.

Alternatively or additionally, the core network 70 may provide updates to these services when required by a user of a portable electronic device 10, 20, 30, 40 or by the network 70. For example, a network 70 may choose to update the operating system of the portable electronic devices 10, 20, 30, 40 when a particularly important software update becomes available.

The portable electronic devices 10, 20, 30, 40 may also comprise circuitry enabling it to operate as a mobile radio telephone. The portable electronic devices 10, 20, 30, 40 may communicate with the fixed cellular network 50 connected to the DVB-H service provider 60 using GSM, GPRS or UMTS, for example, or by using other mobile telecommunications protocols.

In order to receive a first DVB-H service from the core network 70, the user accesses an Electronic Service Guide (ESG) application on a portable electronic device 10 using a user input device 12. The ESG is stored on the portable electronic device 10 and provides information to the user regarding the services provided by the DVB-H service provider 60.

For instance, the ESG may give details of the television channels that are provided by the DVB-H service provider 60. It may inform the user which television programs are provided on those television channels and the times that they start and finish. The ESG may also provide other information about the services provided by the DVB-H service provider 60, such as the news, weather or software update services described above.

The user selects to receive the first service via the ESG by using the user input device 12. In response to the user input, the processor 11 of the portable electronic device 10 controls the mobile telephone circuitry to transmit a request signal/message 110 to the fixed cellular network 50 to request access to the first service. In response to receiving the request message 110, the fixed cellular network 50 transmits a response signal/message 120 to the portable electronic device 10 to enable it to receive the first service.

Alternatively, it may be that the device 10 does not send a request message 110 to the cellular network 50, and the decision to provide the device 10 with the first service is made at the network 70. In this case, the cellular network 50 transmits a message 120 to the device 10 to enable it to “push” the first service onto the device 10. Before the portable electronic device 10 receives the first service, the user may or may not have to accept to receive the first service using the user input device 12.

Alternatively, in one embodiment, the device 10 does not have to receive a message 120 from the cellular network 50 to enable the device 10 to receive the first service. In this embodiment, data enabling the device 10 to receive the first service 10 is stored in the storage device 16. When the user selects to receive the first service via the ESG, the processor 11 retrieves this data and configures the device 10 to receive the first service.

While the user is using the first service, he may also wish to access a second service that is provided by the DVB-H service provider 60. Alternatively, the network 70 may wish to provide a second service to him while he is using the first service.

However, it may be that the portable electronic device 10 does not have sufficient resources to provide more than one service. For instance, the portable electronic device 10 may not have sufficient processing resources or a sufficient amount of available memory in the storage device 16 to provide the services simultaneously to a user.

All or some of the services that are provided by the DVB-H service provider 60 are associated with priority data that is stored in the storage device 16 of the portable electronic device 10. When the portable electronic device 10 does not have sufficient resources to provide all of the services simultaneously to the user that have been requested by the user and/or pushed onto the device 10 by the network 70, the priority data determines which services the portable electronic device 10 will provide to the user.

For example, the priority data may comprise a numeric value indicating a priority level for a service. The number 5 may indicate a service having the highest priority, and the number 1 may indicate that a service has the lowest priority. The priority data relating to some or all of the services may be determined by the user and input by the user using the user input device 12.

Some or all of the priorities for the services may be determined by the network. When the priority data is determined by the network 70, the DVB-H service provider 60 or the fixed cellular network 50 may send a signal to the portable electronic device 10 to update the priority data, either upon request by the user, or periodically. For instance, priority data may be sent by the network 70 in conjunction with updates to the ESG.

The priority level of services may depend upon the type of service. For example, a television program on a television channel may be given a higher priority than software updates for the operating system of the portable electronic device 10, if the software updates are not considered to be critical. Services that can withstand a greater latency may have a lower priority. The priority level may be directly related to the maximum allowed latency of a service or to a quality-of-service (QOS) level assigned to a service.

In some embodiments of the invention, the user is able to override the priority levels set by the network 70 by writing over them. The network 70 may be able to override the priority levels set by the user by writing over them. In some embodiments, the network 70 is able to assign the highest priority level to a service but the user is not, enabling the network 70 to determine which services are given the highest priority.

The priority levels may be dynamic and change over time. For example, a software update may be given a relatively low priority level initially. If the software of the portable electronic device is not updated, the priority level increases over time. A software update for a particular piece of software (e.g. the operating system) may also be given a higher priority if the user has not received a software update for that software for a certain period of time.

Referring now to FIG. 3, at step 310 the portable electronic device 10 stores first priority data 18 which is associated with a first service and second priority data 19 which is associated with a second service.

At step 320, the user uses the input device 12 to access the ESG and to select to receive a second service from the DVB-H service provider 60. At step 330, the processor 11 of the portable electronic device 10 assesses whether there are sufficient processing and memory resources available in the portable electronic device 10 to provide the second service to the user.

It may be that resource data is stored in the storage device 16 which indicates the amount of resources that are required to provide the second service. The resource data may merely indicate the type of service that the second service is (e.g. a television channel). In this case, the processor 11 is able to estimate the amount of resources that will be required at the portable electronic device 10 to provide the second service to the user.

Alternatively, the resource data may have been transmitted to the portable electronic device 10 by the network 70 and may indicate more precisely how much processing resources or memory space is required for the portable electronic device 10 to provide the second service to the user effectively.

If the processor 11 determines at step 330 that the portable electronic device 10 has sufficient resources to provide the second service effectively, it provides the second service at step 340.

If the processor 11 determines at step 330 that it does not currently have sufficient resources to provide the second service to the user, at step 350 the processor 11 of the portable electronic device 10 determines whether the portable electronic device 10 is currently providing a different DVB-H service 60 to the user.

In a situation where the processor 11 of the device 10 determines that the portable electronic device 10 is not providing another DVB-H service to the user the method proceeds to step 360. At step 360, the processor 11 of the portable electronic device 10 controls the user output device 13 to inform the user that sufficient resources are not available to provide the second DVB-H service.

However, in this case the portable electronic device 10 is already providing a first service to the user. The processor 11 determines that the portable electronic device 10 is currently providing another DVB-H service to the user at step 350, and the method proceeds to step 370.

At step 370, the processor 11 reads the first priority data 18, associated with the first service and the second priority data, associated with the second service, from the storage device 16 and compares the first priority data 18 with the second priority data 19.

In comparing the first and second priority data 18, 19, the processor 11 determines whether the second service has a higher priority than the first service.

If the comparison shows that the first service has a higher priority level than the second service, the method proceeds to step 380 and then step 420. The processor 11 controls the user output device 13 to inform the user that the device 10 does not have sufficient resources to provide the first and second services simultaneously and that the second service is of a lower priority than the first service, so the second service will not be provided.

The second service is placed in a “cancelled state” or a “queued state”. If the second service is placed in the cancelled state, the device 10 does not receive the second signal 130 which comprises the second content data 7 associated with the second service.

If the second service is placed in the queued state, the device 10 receives the second service at a later point in time, when sufficient resources of the device 10 are available.

In one embodiment, once sufficient resources become available, the processor 11 controls the transceiver 15 to transmit a request signal/message 150 to the fixed cellular network 50 to request access to the second service. In response to receiving the request message 150, the fixed cellular network 50 transmits a response signal/message 160 to the portable electronic device 10 to enable it to receive the second service. The device 10 then receives the second signal 130 in order to provide the second service to the user.

In an alternative embodiment, data enabling the device 10 to receive the second service is stored in the storage device 16. Once sufficient resources become available, the processor 11 retrieves this data and configures the device 10 to receive the second service.

In a situation where the second service is placed in the queued state and the processor 11 determined at step 330 that the device 10 had sufficient memory resources to store content data 7, 8 relating to the first and second services but did not have sufficient processing resources to provide the first and second services simultaneously, the processor 11 may control the transceiver 15 to send a request message 150 to receive the second signal 130. When the response signal/message 160 is received from the cellular network 50, the device 10 may begin to receive the second signal 130. The device 10 then restricts use of the second signal 130 so that the second content data 7 is stored in the storage device 16 without the processor 11 processing or decoding the second content data 7 to provide an output to the user via the user output device 13.

Once sufficient processing resources become available (e.g. when the processor 11 has finished processing the first content data 8 relating to the first service) the processor 11 begins to process the second content data 7 to output the second service to the user via the user output device 13.

If the comparison shows that the second service has a higher priority level than the first service at step 370, the method proceeds to step 390. The processor 11 then suspends use of the first signal 140. The first service is put into a “cancelled state” or a “queued state” by the processor 11.

If the first service is placed in the cancelled state or the queued state, the computational resources that were being used to provide the first service are re-allocated to the second service by the processor 11, and the device 10 ceases to provide the first service to the user.

The processor 11 controls the user output device 13 to inform the user that the device 10 does not have sufficient resources to provide both of the services concurrently and that the second service is of a higher priority than the first service, so the second service will be provided to the user rather than the first service.

If the first service is placed in the cancelled state, the processor 11 controls the transceiver 15 not to receive the first signal 140 which comprises the first content data 8 associated with the first service. The processor 11 may or may not delete some or all of the first content data 8 that is stored in the storage device 16.

For instance, if the first service is a television channel, the processor 11 may delete the first content data 8 that is stored in the stored device 16 which has not yet been processed/decoded by the processor 11 and output to the user. However, if the first service is a weather update service and the first content data 8 relates to weather information, for example, the first content data 8 may not be deleted. A display of the device 10 may continue to display the stored weather information, but may also indicate that the information is out of date or needs updating.

If the first service is placed in the queued state, once sufficient computational resources become available, the processor 11 controls the transceiver 15 to begin receiving the first service again.

In the situation where the first service is placed in the queued state and the processor 11 determined at step 330 that the device 10 had sufficient memory resources to store content data 7, 8 relating to the first and second services but did not have sufficient processing resources to provide the first and second services simultaneously, the processor 11 may control the transceiver 15 to continue to receive the first signal 140. The device 10 then restricts use of the first signal 140 so that the first content data 8 is stored in the storage device 16 without the processor 11 processing or decoding the first content data 8 to provide an output to the user via the user output device 13.

Once sufficient processing resources become available (e.g. when the processor 11 has finished processing the second content data 7 relating to the second service) the processor 11 begins to process the first content data 8 to output the second service to the user via the user output device 13.

In the event that the comparison shows that the first service and the second service have the same priority level, the method proceeds from step 370 to step 380 and then step 400. At step 400, the processor 11 controls the user output device 13 to inform the user that the device 10 does not have sufficient computational resources to provide both of the services and instructs the user to use the user input device 12 to select which of the services he wishes to receive.

When the user has selected which service that he wishes to receive, the processor 11 proceeds as described above in relation to steps 390 and 420, depending on which service is selected.

Alternatively, when the comparison shows that the first service and the second service have the same priority level, the device 10 may continue to provide the first service and place the second service in the cancelled state or the queued state. The processor 11 may also control the user output device 13 to inform the user that sufficient computational resources are not available to provide the first and second services concurrently.

As mentioned above, the priority levels that are associated with services may be dynamic and change over time. When either the first or second service has been queued, the processor 11 may be operable to compare the first and second priority data whenever either the first or second priority data 18, 19 change or the first or second priority levels change. Alternatively, the processor 11 may be operable to compare the first and second priority data 18, 19 periodically.

Consider a situation where the second service is being provided by the device 10 and the first service is in the queued state. If the first or second priority data changes and the comparison between the first and second priority data indicates that the priority of the first service is now higher than second service, the processor 11 is operable to re-allocate the computational resources of the device 10 by providing the first service to the user and placing to the second service in a queued state. The processor 11 may also be operable to control the user output device 13 to inform the user that the priority level of one of the services has changed, resulting in a change in the service that is being provided to the user.

A method has been described which enables an electronic device 10 to prioritize which signal it uses depending on priority data associated with that signal. The device 10 is therefore able to prioritize its computational resources automatically (i.e. without user intervention) depending on the importance of the signal.

Although embodiments of the present invention have been described in the preceding paragraphs with reference to various examples, it should be appreciated that modifications to the examples given can be made without departing from the scope of the invention as claimed.

Although embodiments of the invention have been described in relation to two services being provided concurrently by a portable electronic device 10, it should be appreciated that embodiments of the invention may be applicable when a device is used to provide more than two services. Where the device is used to provide more than two services, a list comprising the services that are being provided and those that are in the queued state may be maintained by the processor 11 in the storage device 16. The services may be ordered according to their priority levels. The list may be dynamically varied as the priority of a service changes with time. In particular, as latency that a service can withstand decreases its priority level may increase. Thus, some services may move up the list relative to others with time.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An electronic device, comprising:
a storage device operable to store first priority data associated with a first signal, and second priority data associated with a second signal; and
a processor operable to compare the first priority data and the second priority data, and when the second priority data is indicative of a higher priority than the first priority data, to use the second signal while suspending use of the first signal.

2. An electronic device as claimed in claim 1, wherein the processor is operable to determine whether the electronic device is able to use the first and second signals simultaneously, and if not, the processor compares the first priority data and the second priority data in order to suspend use of one of the first and second signals.

3. An electronic device as claimed in claim 1, wherein when the processor has used the second signal, it then uses the first signal.

4. An electronic device as claimed in claim 1, wherein the first signal is associated with first content and includes first content data, the second signal is associated with second content and includes second content data, and following the comparison of the first priority data and the second priority data, the processor begins to process the second content data to output the second content to a user before it processes the first content data to output the first content to a user.

5. An electronic device as claimed in claim 4, wherein the first priority data is dependent upon the first content and the second priority data is dependent upon the second content.

6. An electronic device as claimed in claim 4, wherein the first priority data is dependent upon a content type of the first content, and the second priority data is dependent upon a content type of the second content.

7. An electronic device as claimed in claim 1, wherein the first priority data is dependent upon when the first signal was last used.

8. An electronic device as claimed in claim 1, wherein the first priority data changes while the use of the first signal is suspended.

9. An electronic device as claimed in claim 8, wherein when the first priority data changes, the processor is operable to compare the first priority data and the second priority data, and when the first priority data is indicative of a higher priority than the second priority data, to use the first signal while suspending use of the second signal.

10. An electronic device as claimed in claim 8, wherein the electronic device comprises a user output device, and when the first priority data is indicative of a higher priority than the second priority data, the processor is operable to control the user output device to indicate to the user that the first priority data has changed to be indicative of a higher priority than the second priority data.

11. An electronic device as claimed in claim 1, wherein the electronic device comprises a user input device for inputting the first priority data and the second priority data.

12. An electronic device as claimed in claim 1, wherein the electronic device comprises a receiver for receiving the first and second priority data from a source external to the electronic device.

13. An electronic device as claimed in claim 1, wherein the electronic device comprises a receiver for receiving the first signal from a source external to the electronic device and the second signal from a source external to the electronic device.

14. An electronic device as claimed in claim 13, wherein the first and second signals are transmitted to a number of electronic devices, including the said electronic device.

15. An electronic device as claimed in claim 1, wherein the first and second signals are broadcast or multicast radio frequency signals and the electronic device comprises a radio frequency receiver for receiving the first and second signals.

16. An electronic device as claimed in claim 13, wherein when the second priority data is indicative of a higher priority than the first priority data, the processor is operable to control the receiver to receive the second signal and not to receive the first signal.

17. An electronic device as claimed in claim 15, wherein the first signal is associated with first content provided by a network and comprises first content data, and the second signal is associated with second content provided by the network and comprises second content data.

18. An electronic device as claimed in claim 16, wherein the receiver is for receiving the first and second priority data from the network.

19. An electronic device as claimed in claim 16, wherein the electronic device comprises a transmitter, and the processor is operable to control the transmitter to request the second content from the network.

20. An electronic device as claimed in claim 18, wherein the electronic device comprises a user input device for enabling a user to select to receive the second content from the network, and following a user selection to receive the second content, the processor is operable to determine whether the electronic device has sufficient computational resources to provide the first and second content simultaneously to a user.

21. An electronic device as claimed in claim 20, wherein the determination of whether the electronic device has sufficient computational resources to provide the first and second content simultaneously to a user is based upon the available computational resources of the electronic device.

22. An electronic device as claimed in claim 19, wherein the determination of whether the electronic device has sufficient computational resources to provide the first and second content simultaneously to a user is based at least upon the amount of available memory space in the storage device of the electronic device.

23. An electronic device as claimed in claim 19, wherein the electronic device is portable and comprises circuitry enabling the electronic device to operate as a mobile radio telephone.

24. A method of using a signal in an electronic device, comprising:
storing first priority data associated with a first signal, and second priority data associated with a second signal; and
comparing the first priority data and the second priority data; and
using the second signal while suspending use of the first signal, when the second priority data is indicative of a higher priority than the first priority data.

25. A computer program for use in an electronic device, comprising:
means for comparing stored first priority data, associated with a first signal, and stored second priority data, associated with a second signal; and
means for using the second signal while suspending use of the first signal, when the second priority data is indicative of a higher priority than the first priority data.

26. A chipset for use in an electronic device, comprising:
means for comparing stored first priority data, associated with a first signal, and stored second priority data, associated with a second signal; and
means for using the second signal while suspending use of the first signal, when the second priority data is indicative of a higher priority than the first priority data.

27. An electronic device, comprising:
a storage device operable to store first priority data indicating a first priority level, associated with a first signal, and second priority data indicating a second priority level, associated with a second signal; and a processor operable to compare the first priority level and the second priority level, and operable to select for use one of the first and second signals and to restrict use of the other of the first and second signals in dependence on the comparison.
